(19) United States
(12) Patent Application Publication
(10) Pub. No.: US 2009/0276153 A1
(43) Pub. Date: Nov. 5, 2009

(54) Navigating method and navigation apparatus using road image identification

(76) Inventor: Chun-Huang Lee, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,412

(22) Filed: May 1, 2008

(51) Int. Cl. G01C 21/36

(52) U.S. Cl. 701/210; 701/209

(57) ABSTRACT

A navigating method and a navigation apparatus capable of real-time road image identification are disclosed. The apparatus equips a camera used to capture the road image in some specific sections, and the image is used to be identified, so that the navigation accuracy can be improved. The preferred embodiment of the navigating method includes the steps of determining a section to be identified, and capturing the road image by means the camera installed in a vehicle, and retrieving the digitized road image which is used to compare the road image from an image database synchronously, and identifying the road, and transferring the identification result to a navigation system for producing the navigation information via vocal or a displayer.

### BACKGROUND OF THE INVENTION

1. Field of the Invention

The present invention relates to a navigation apparatus using road image identification and navigating method; in particular, to the improvement of accuracy in general automobile navigation by means of the road image identification system.

2. Description of Related Art

Navigation System has now become one popular and common tool which people daily need, especially in the transportation application of road guiding for automobile driving. The navigation system usually cooperates with the Global Positioning System (GPS), which, at the current stage, provides global positioning based on microwave signals transmitted by at least 24 satellites installed along earth orbit in space, which is generally depicted in FIG. 1.

FIG. 1 illustrates a device diagram of general navigation equipment, which is basically used for automobile travel and navigation, locates the position of the automobile through the signals communicated between a specific number (usually more than 3) of satellites 10 and the travel positioning system, and further uses the position information in a specific period of time to determine the speed and travel direction of the automobile. It consists of a GPS receiver 14 used for receiving the signals transmitted by the satellites 10, and the received signals can be processed by a control unit 12 to derive the current position through longitude/latitude operations. Meanwhile, the road map corresponding to the current position may be retrieved from a map database 16, and, in conjunction with longitude/latitude operations for positioning effect, together with the front/back signal operations, it is possible to obtain the required information for navigation, e.g. relative moving speed, directions etc. The control unit 12 shown in the Figure is further electrically connected to a display driving unit 17 and, by means of a display unit 18, the navigation information such as positioning information and maps may be visually presented to the user, or electrically connected to a vocal guiding unit 19 for delivering navigation information via vocal prompt.

FIG. 2 generally illustrates a navigation system architecture, which includes a travel information server 22 connected to the navigation device via Internet 20, and the navigation device itself is equipped with a positioning system 26 and a wireless device 24.

The travel information server 22 provides map information and travel routes. The positioning system 26 collects information from multiple satellites for locating the position of the automobile equipped with such a navigation device, and consists of a wireless communication system 261, such as cellular phone or satellite paging system. The wireless device 24 shown in the Figure links to the wireless communication system 261 in the positioning system 26 through wireless communication for obtaining the automobile positioning information, and then links to the travel information server 22 through Internet 20, allowing users to get complete travel guide information.

Although the above-mentioned satellite navigation system indeed offers practical convenience in traveling or positioning features, many problems arise due to insufficient precision in the navigation information. For example, insufficient resolution in maps may result in navigation error as driving along small paths; or, unable to quickly respond when passing by some cross-road or branch way where critical choice must be made, and this may also cause the driver to decide a wrong way; additionally, when the navigation system encounters viaducts in neighboring area, it is difficult to determine whether the system is now moving on the ground road or on a viaduct, thus navigation error might occur.

### SUMMARY OF THE INVENTION

The present invention discloses a navigation apparatus for road image identification and a navigating method, which, in order to overcome the restrictions resulting from special road conditions found in conventional navigation system, specifically employs the process of road image capture and road image identification to enhance accuracy of general travel navigation. The embodiments of the present invention aim essentially to perform road identification on two parallel roads leading to different destinations in which the auxiliary navigation system can correctly prompt a driver with the desired driving direction, or to perform route re-planning based on driver's driving route; or, when passing through a road section with viaducts located nearby, determining whether the automobile is running on a viaduct or on a ground road, so as to assist the navigation system to correctly decide and schedule appropriate driving route.

The preferred embodiment of the navigation system using road image identification includes a road image process system for executing road image capture and identification, which provides a camera device installed on the vehicle such as automobiles or motorcycles, and through the process performed by the said road image process system, recorded road images can be retrieved from an image database for comparing the image captured in real-time with the recorded road image saved in the database, so as to determine the road on which the automobile is now cruising.

Subsequently, it identifies the road the automobile is currently driving through and sends the identification result to the navigation system in this navigation apparatus, and the said navigation system receives positioning signals of the navigation system so as to, in conjunction with the information from the linked map database, generate complete positioning information. Finally, the correct and complete navigation information can be output through an information output system, including the navigation route or information displayed on a displayer, or by means of vocal prompt to remind a driver of current driving conditions on the road.

The navigating method of road image identification according to the present invention includes: first, determining whether it is to pass through the road section to which the road image identification needs to be applied. In case YES, meaning to perform image identification on the said road, then the identification mechanism can be initiated, and a digitized image of this road can be taken and captured by a camera device installed on the automobile. After that, the mechanism retrieves a recorded road image stored in an image database, and performs road identification process through time-synchronized image comparison; after the identification process, it creates an identification result and transfers this result to the navigation system, then generates navigation information; wherein the embodiments thereof include: providing prompt to a driver by means of vocal or displayed information when passing by two parallel or branched roads leading to different destinations; or as driving through viaducts along a road section, in additional to the navigation system which reminds driver of the suitable route through road image identification, also offering real-time navigation information when wrong road being selected.

### BRIEF DESCRIPTION OF THE DRAWINGS

FIG. 1 shows a device diagram of satellite navigation apparatus of prior art;

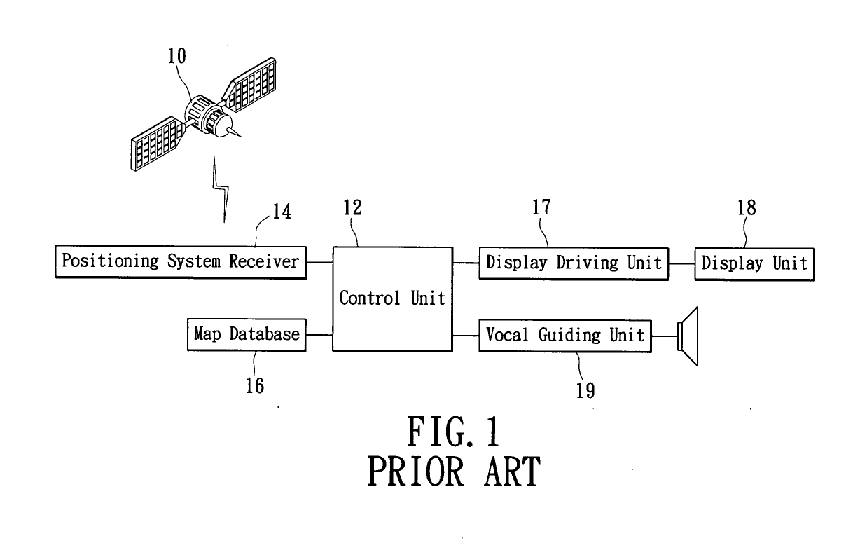

FIG. 2 shows a navigation system architecture diagram of prior art;

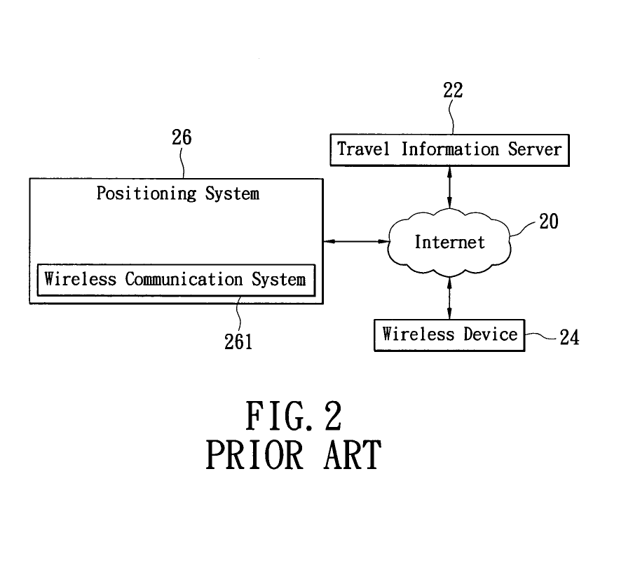

FIG. 3 shows a road condition diagram;

FIG. 4 shows another road condition diagram;

FIG. 5 shows a functional block diagram of an embodiment of navigation apparatus using road image identification according to the present invention; and

FIG. 6 shows a flowchart of en embodiment of navigating method using road image identification according to the present invention.

### DETAILED DESCRIPTION OF THE PREFERRED EMBODIMENTS

The present invention discloses a navigation apparatus using road image identification and navigating method, which improves the restrictions on the conventional navigation system based on different road conditions, wherein the embodiments directed to special road conditions include at least:

case 1: as passing by some cross-road or branch way, performing road identification on the two parallel or branched roads leading to different destinations by means of the road identification system;

case 2: as driving through/by a viaduct along a road section, through the road identification system, providing assistance in determining whether the automobile is currently driving on a viaduct or on a general ground road.

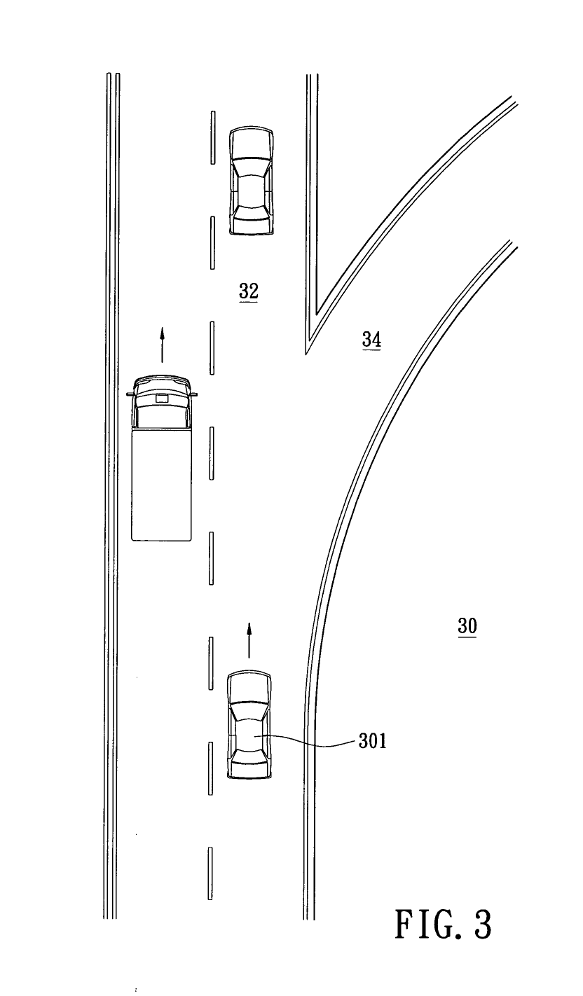

In the a road condition diagram shown as FIG. 3, when the automobile 301 drives to a road section 30 having a branch road, due to insufficient resolution provided by the navigation system installed thereon, it is unable to clearly display the planned route on the screen. However, through the map database provided in the navigation system installed on the automobile, it is possible to appreciate the road that is about to pass through and needs to be identified. For example, when the navigation system is unable to clearly show the first road 32 and the second road 34 on the screen, the road image identification mechanism offered by the present invention, i.e. the navigation apparatus using road image identification, can then be initiated, which, by means of image comparison with an image stored in an image database (not shown), performs image identification process on the first road 32 and the second road 34 shown in the Figure while approaching to the branch road, the further via a vocal system (not shown) prompts the driver to take the second road 34 on the right, or alternatively the first road 32 on the left and straight ahead.

Additionally, if the driver still missed at the said branch which requires correct selection, the navigating apparatus using road image identification according to the present invention may also first determine the road on which the driver is drive, and then immediately re-plan and modify the navigation route for the driver's reference.

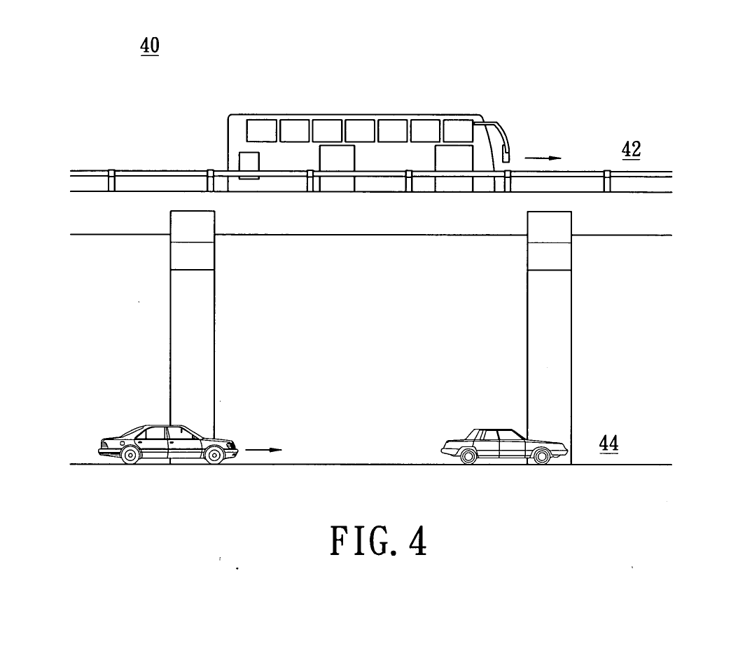

FIG. 4 shows another road condition diagram, wherein the automobile is driving on a road section 40 with viaducts located in the vicinity, thus the route of the running automobile may probably on a viaduct 42 or on a ground road 44. Since a general navigation system receiving positioning signals transmitted from satellites may not be able to distinguish whether the automobile is currently driving on a viaduct or a ground road, thus, when driving through such a road section, it may employ the navigating apparatus using road image identification according to the present invention to perform road image identification on the road the automobile is now driving by. Similarly, through the map database in the navigation system installed on the automobile, it is possible to appreciate the road section the automobile is driving by and needs to be identified; i.e. the road image identification mechanism can be initiated, and such mechanism can compare the captured road image with the image stored in the above-mentioned image database (not shown), so as to determine whether the automobile is now running on the viaduct 42 or on the ground road 44.

After that the road section the automobile is currently driving through has been determined, the navigation route can be modified or re-planned for the appropriate one, should there be any discrepancy between the determination and the originally planned route.

The navigation apparatus using road image identification and navigating method disclosed by the present invention is not limited to the above-mentioned two situations, but also applicable to other road sections possibly confusing the driver, including identification on much more complicated cross road, wherein the preferred embodiment thereof records, in the map database of the navigation system, tags for the places where road identification process are specifically required, and through the map database, it is possible to be aware of the road section with a tag that the automobile is currently passing by, then the road image process system may be initiated for road image capture and identification, further with the assistance offered by the original navigation system, more precise navigation effect can thus be acquired.

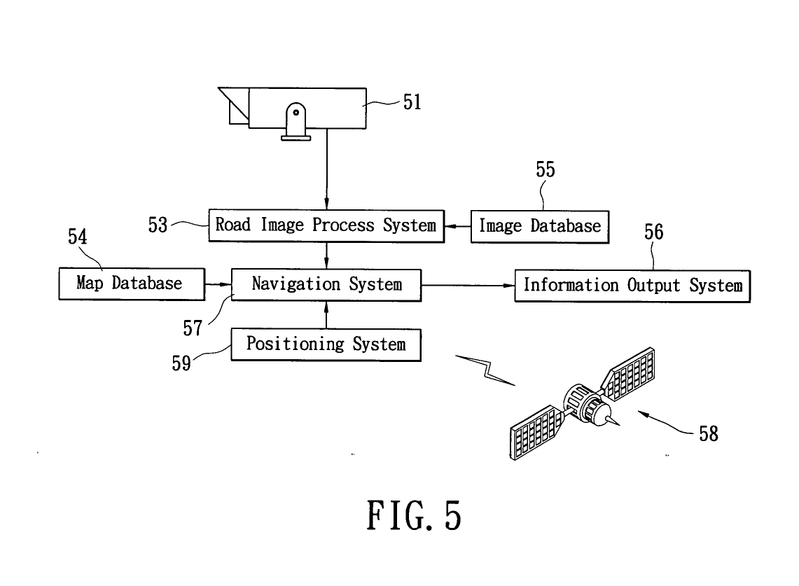

FIG. 5 shows a functional block diagram of an embodiment of navigation apparatus using road image identification according to the present invention, which performs, essentially through the road image process system 53 shown in the Figure, road image capture and identification, wherein the road image process system 53 is electrically connected to a camera device 51. The camera device 51 is installed on vehicles such as motorcycles or automobiles, so as to take road image in front of the automobile. The generated image signals are processed by the road image process system 53 and, meanwhile, a plurality of special road image data are introduced from an image database 55. Thus, the road image process system 53 compares the captured image in real-time with the recorded image from the image database, so as to determine the road the automobile is now driving through. Here, the plurality of special road image data include road sections for which performance of road image identification are required, and road characters presented at/near these road sections. For example, road character comparison may be based on traffic signs, ground guide lines, pathway trees, buildings on each side of the road, or any other possible features along the road.

The embodiment of the above-mentioned image database 55 may be a built-in database installed inside the navigation apparatus, or a remote database linkable via network or other wireless connection, and may update the image data recorded therein anytime, so as to enhance the correctness of road identification.

The road image process system 53 is electrically connected to a navigation system 57, which is in turn connected to a map database 54, so as to generate navigation route. The map database 54 has a plurality of tags (not shown), which correspond to the road sections of the plurality of special road image data recorded in the image database 55. When the navigation route approaches a tagged road section and gets close by a certain distance, it will inform the navigation apparatus to initiate the said road image identification mechanism through the road image process system 53. When, informed by the navigation system 57, the road section currently driving through and in need of road image identification has been received via the road image process system 53, the road image identification mechanism will be initiated, which compares the road image captured by the camera device with the recorded special road image data stored in the image database, generates a road identification information and then transfers the said road identification information to the navigation system 57 in the navigation apparatus.

The aforementioned navigation system 57 is further electrically connected to a positioning system 59, which receives positioning signals transmitted from a plurality of satellites through equipments such as antenna, receiver (not shown), so as to locate the automobile or other vehicles equipped with such a navigation apparatus, and, in conjunction with the information from the map database 54 connected by the navigation system 57, generate complete positioning information.

Subsequently, the navigation system 57 receives the identification information sent by the road image process system 53 and the positioning signal from the positioning system 59, and, after integration, determines the road currently driving through and other possible confusing road conditions ahead, such as the above-mentioned branch road, viaduct or some confusing road situation. The information output system 56, which is electrically connected via the navigation system 57, outputs the correct navigation information, wherein the output information may include navigation route or information displayed on a displayer (not shown), or vocal prompt to remind driver of the present driving condition, provided for driver's references on drive lane switching, right turn, left turn and the like.

Another situation may be that, as soon as the navigation apparatus with road identification ability finds, after identification, the driver has deviated from the originally planned route, it can immediately modify or re-plan the navigation route.

The embodiment of navigation apparatus using road image identification shown in the above-mentioned FIG. 5 is mainly characterized in the image identification system and navigation system installed on the automobile, which uses road image capture technology to capture road image appearing in front, and, through road image identification, to identify the road on which the running automobile is now driving, correcting the navigation system by means of road image identification at due time, and is able to prompt the driver through voice device with guides to drive in inner lane or outer lane of the road or heading for other direction when approaching to some road section or joint where the selection is required.

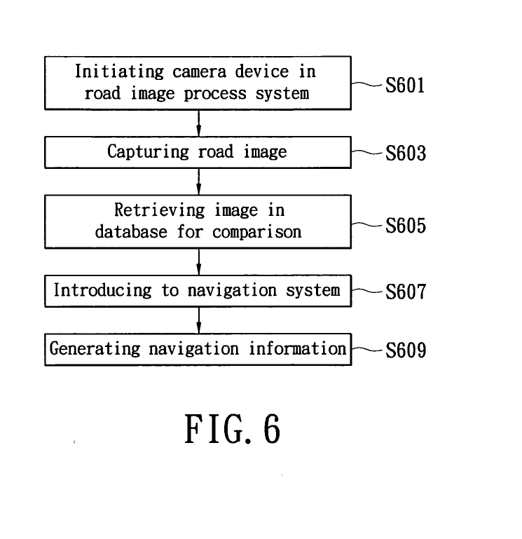

FIG. 6 shows a flowchart of the said navigating method.

The process flow starts at step S601. When an automobile or other vehicle equipped with the navigation apparatus according to the present invention is about to pass by a road section marked with a tag in the map database, the camera device in the road image process system is initiated as it approaches within a certain distance from the road section (step S601);

Road image capture is performed using the camera device on the automobile, whose embodiments include, for example, through a camera consisting of photo-sensing components, e.g. CCD or CMOS, installed in the front side of the automobile to capture road image as passing by the above-mentioned road section to be identified, or by user-initiated image capture function to take a road image (step S603), in which the road image is a digitized road image captured by the camera device.

Subsequently, comparison process is performed on the said road image and a recorded special road image data from an image database (step S605). In this step, it is to compare the road characters of the captured road image with the ones of the stored special road image data, e.g. traffic signs, ground guide lines, pathway trees, buildings on each side of the road, or any other possible features along the road, so as to determine the actual road conditions. In this way, it is possible to identify the above-mention situation 1 of passing by a road section with two parallel or branched roads leading to different destinations, and situation 2 of whether running on a viaduct or on a general ground road as driving through a road section with viaduct located nearby. The image database may be a built-in database of the navigation apparatus, or a remote database linkable via network or other wireless connection.

After the process of identification, the identification result can be generated and sent to the navigation system (step S607), which then creates navigation information (step S609), wherein the embodiments thereof include:

case 1: when passing by a road section with two parallel or branched roads leading to different destinations, if the previously planned route that the navigation system scheduled earlier is to select the right side, then the navigation system may remind the driver of going right through vocal prompt or visual display on screen, and if it was planned to go left, then navigation system can hind for the left route; however, suppose the driver should choose the wrong way, then the navigation system may re-plan or modify the route after road image identification, then prompt the driver by vocal device or visually on screen;

case 2: when driving through a road section with viaducts located in vicinity, the navigation system may not only remind the driver of the correct way to drive via road identification process, it can also provide navigation information in real-time upon erroneously choice of route. In case the originally planned route scheduled by the navigation system is viaduct, but the driver is driving on a ground road, then after road image identification, it may re-plan or modify the original route immediately; contrarily, suppose the originally planned route is ground road but the driver should drive on a viaduct, then after road image identification, it may analogously re-plan or modify the route immediately.

In summary, the present invention relates to a navigation apparatus using road image identification and navigating method, which is essentially used for assisting general navigation system by means of road image identification system installed on automobile, so as to provide more accurate navigation service.

The aforementioned descriptions illustrate merely the preferred and practical embodiments of the present invention, without any intention to restrict the scope of the present invention thereto. Hence, all modifications, changes or substitutions equivalent in structure and designated based on the specification and appended drawings of the present invention are reasonably encompassed within the scope of the present invention defined in the claims hereunder.

What is claimed is:

1. A navigation apparatus using road image identification, comprising:
an image database, including a plurality of special road image data;
a road image process system, including a camera for capturing a road image, in which the road image and one of the plurality of special road image data are compared to generate a road identification information;
a navigation system, electrically connected to the road image process system so as to receive the road identification information from the road image process system, receive map information from a map database, and generate a navigation route using both inputs;
a positioning system, electrically connected to the navigation system for receiving positioning signals from a plurality of satellites and providing the received positioning signals to the navigation system; and
an information output system, electrically connected to the navigation system to output navigation information.

2. The navigation apparatus using road image identification according to claim 1, wherein said camera is installed on a vehicle so as to capture a road image on the front side of the vehicle.

3. The navigation apparatus using road image identification according to claim 1, wherein the image database is a built-in storage database of the navigation apparatus.

4. The navigation apparatus using road image identification according to claim 1, wherein the image database is a remote database linkable via network or other wireless connection.

5. The navigation apparatus using road image identification according to claim 1, wherein the information output system prompts the driver of the navigation information through a vocal device.

6. The navigation apparatus using road image identification according to claim 1, wherein the information output system prompts the driver of the navigation information through display device.

7. The navigation apparatus using road image identification according to claim 1, wherein the map database of the road image process system has a plurality of tags which are set respectively corresponding to the road sections of the special road information.

8. The navigation apparatus using road image identification according to claim 7, wherein the road image process system initiates the camera device at road sections for which a tag is marked in the map database.

9. A navigating method using road image identification, comprising:
capturing a road image by means of a camera device installed on a vehicle;
comparing the captured road image with one of the special road images stored in an image database;
transferring the comparison result to a navigation system;
introducing a positioning signal into the navigation system;
determining whether the vehicle deviates from the originally planned navigation route;
if it does not deviate from the originally planned navigation route, reminding the driver in the vehicle of the driving route at the road section where important selection is required to make; and
if it does deviate from the originally planned navigation route, re-planning the route by means of the navigation system and reminding the driver in the vehicle.

10. The navigating method using road image identification according to claim 9, wherein the step of performing road identification is performed when the vehicle passes by a road section with two parallel or branched roads leading to different destinations.

11. The navigating method using road image identification according to claim 9, wherein the step of performing road identification is performed when the vehicle passes a road section with viaducts in its vicinity, so as to identify whether the vehicle is running on the viaduct or the ground road.

12. The navigating method using road image identification according to claim 9, wherein the image database is a built-in storage database of the navigation apparatus.

13. The navigating method using road image identification according to claim 9, wherein the image database is a remote database linkable via network or other wireless connection.

14. The navigating method using road image identification according to claim 9, wherein the driver in the vehicle is prompted through a vocal device.

15. The navigating method using road image identification according to claim 9, wherein the driver in the vehicle is prompted through a display device.

16. The navigating method using road image identification according to claim 9, wherein the navigation system includes a map database having a plurality of tags, which are set respectively corresponding to the road sections of the special road information.

17. The navigating method using road image identification according to claim 16, wherein the road image process system initiates the camera device at road sections for which a tag is marked in the map database.
